(19) United States
(12) Patent Application Publication
(10) Pub. No.: US 2024/0232686 A1
(43) Pub. Date: Jul. 11, 2024

(54) Portion-Specific Model Compression for Optimization of Machine-Learned Models

(71) Applicant: Google LLC, Mountain View, CA (US)

(72) Inventors: Yicheng Fan, Mountain View, CA (US); Jingyue Shen, Santa Clara, CA (US); Deqiang Chen, San Jose, CA (US); Peter Shaosen Young, Mountain View, CA (US); Dana Alon, Mountain View, CA (US); Erik Nathan Vee, San Mateo, CA (US); Shanmugasundaram Ravikumar, Piedmont, CA (US); Andrew Tomkins, Menlo Park, CA (US)

(21) Appl. No.: 18/012,292

(22) PCT Filed: Jul. 29, 2022
(86) PCT No.: PCT/US2022/038937

§ 371 Date: Feb. 1, 2024

(51) Int. Cl. G06N 20/00

(52) U.S. Cl. CPC G06N 20/00

(57) ABSTRACT

Systems and methods of the present disclosure are directed to portion-specific compression and optimization of machine-learned models. For example, a method for portion-specific compression and optimization of machine-learned models includes obtaining data descriptive of one or more respective sets of compression schemes for one or more model portions of a plurality of model portions of a machine-learned model. The method includes evaluating a cost function to respectively select one or more candidate compression schemes from the one or more sets of compression schemes. The method includes respectively applying the one or more candidate compression schemes to the one or more model portions to obtain a compressed machine-learned model comprising one or more compressed model portions that correspond to the one or more model portions.

### FIELD

The present disclosure relates generally to machine-learned model optimization. More particularly, the present disclosure relates to portion-specific compression of machine-learned models.

### BACKGROUND

Distributed computing service systems (e.g., cloud computing platforms, etc.) provide a variety of services to implement machine learned models for various tasks and applications. Specifically, cloud computing services may build, train, and/or compress machine-learned models based on the needs of users. However, the application of compression schemes to machine-learned models can substantially reduce the overall accuracy of the machine-learned models. As such, techniques that reduce, or eliminate, this loss in accuracy are desired.

### SUMMARY

Aspects and advantages of embodiments of the present disclosure will be set forth in part in the following description, or can be learned from the description, or can be learned through practice of the embodiments.

One example aspect of the present disclosure is directed to computer-implemented method for portion-specific compression and optimization of machine-learned models. The method includes obtaining, by the computing system, data descriptive of one or more respective sets of compression schemes for one or more model portions of a plurality of model portions of a machine-learned model. The method includes evaluating, by the computing system, a cost function to respectively select one or more candidate compression schemes from the one or more sets of compression schemes. The method includes respectively applying, by the computing system, the one or more candidate compression schemes to the one or more model portions to obtain a compressed machine-learned model comprising one or more compressed model portions that correspond to the one or more model portions.

Another example aspect of the present disclosure is directed to a computing system for portion-specific compression and optimization of machine-learned models. The computing system includes one or more processors. The computing system includes one or more non-transitory computer-readable media that store instructions that, when executed by the one or more processors, cause the computing system to perform operations. The operations include obtaining data descriptive of one or more respective sets of compression schemes for one or more model portions of a plurality of model portions of a machine-learned model. The operations include evaluating a cost function to respectively select one or more candidate compression schemes from the one or more sets of compression schemes. The operations include respectively applying the one or more candidate compression schemes to the one or more model portions to obtain a compressed machine-learned model comprising one or more compressed model portions that correspond to the one or more model portions.

Another example aspect of the present disclosure is directed to one or more non-transitory computer-readable media that store instructions that, when executed by one or more processors, cause the computing system to perform operations. The operations include from the user device associated with a user, data descriptive of a selection of one or more candidate compression schemes from one or more respective sets of compression schemes for compression of one or more respective model portions of a plurality of model portions of a trained machine-learned model. The operations include applying the one or more compression schemes to one or more respective model portions of the plurality of model portions of the trained machine-learned model to obtain a compressed machine-learned model.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs portion-specific compression of machine-learned models according to example embodiments of the present disclosure.

FIG. 1B depicts a block diagram of an example computing device that performs portion-specific compression and optimization of machine-learned models according to example implementations of the present disclosure.

FIG. 1C depicts a block diagram of an example computing device that performs distillation training for portion-specific optimization of machine-learned models according to example implementations of the present disclosure.

FIG. 2A depicts a block diagram of an example computing system that evaluates a cost function to determine candidate compression scheme(s) according to some embodiments of the present disclosure.

FIG. 2B depicts a block diagram of an example computing system that compresses portions of an uncompressed machine-learned model to obtain a compressed machine-learned model according to some implementations of the present disclosure.

FIG. 2C depicts a block diagram of an example computing system that trains compressed portions of a compressed machine-learned model via distillation training from corresponding uncompressed portions of a corresponding uncompressed model according to some implementations of the present disclosure.

FIG. 3 is a data flow diagram that illustrates selection of compression schemes using a combinatorial search space according to some implementations of the present disclosure.

FIG. 4 is a block diagram that illustrates an example layer-wise search space that can be utilized by a cost function according to some implementations of the present disclosure.

FIG. 5 depicts a flow chart diagram of an example method to perform portion-specific compression of machine-learned models according to example implementations of the present disclosure.

Reference numerals that are repeated across plural figures are intended to identify the same features in various implementations.

### DETAILED DESCRIPTION

### Overview

Generally, the present disclosure is directed to machine-learned model optimization. More particularly, the present disclosure relates to portion-specific (e.g., specific to layers, tensors (e.g., data arrays of weight values characterizing weights between corresponding pairs nodes of the machine-learning model (i.e. the influence which the output of a first node of the pair has on the output of the second node of the pair)), groupings of layers and/or tensors, etc.) compression of machine-learned models. Specifically, as an example, a computing system can obtain data descriptive of one or more respective sets of compression schemes for one or more model portions of a machine-learned model (e.g., layer(s), tensor(s), parameter grouping(s) (e.g. the parameters of the machine learning model may include weight values as discussed above, and may include other numerical parameters, such as offset values associated with nodes (e.g. a given node may output a value which is function of the weighted input to the node plus an offset value for the node): a “parameter grouping” refers to a plurality of these parameters), etc.). For example, a user can provide data via a user device that describes set(s) of compression schemes that correspond to portion(s) of a machine-learned model. The computing system can evaluate a cost function to respectively select candidate compression schemes from the set(s) of compression scheme(s). For example, the cost function may seek to optimize an accuracy of the model while limited by a latency constraint (e.g., a limit of floating point operations per second, etc.). The computing system can determine a candidate compression scheme from each set of compression schemes that collectively optimize the cost function. The computing system can apply the candidate compression scheme(s) to the model portion(s) to obtain a compressed machine-learned model that includes the compressed model portion(s).

In some implementations, the compressed machine-learned model can be trained via distillation of the machine-learned model. For example, the one or more compressed portions of the machine-learned model can be trained via distillation of the corresponding one or portions of the uncompressed machine-learned model.

In such fashion, a computing system can collectively determine candidate compression scheme(s) for application to model portion(s) according to a cost function to obtain a compressed machine-learned model that retains capabilities (e.g., accuracy, etc.) substantially similar to, or greater than, the corresponding uncompressed machine-learned model.

Systems and methods of the present disclosure provide a number of technical effects and benefits. As one example technical effect and benefit, the utility of trained machine-learned models can often be limited by the size of the models (e.g., utilization of models with mobile devices, wearable devices, etc.). However, conventional compression of machine-learned models can reduce an accuracy of the to a prohibitive degree. By substantially compressing machine-learned models and retaining accuracy, implementations of the present disclosure greatly expand the utility of existing machine-learned models, leading to optimized performance and user experience across a variety of use-cases (e.g., mobile computing, wearable devices, etc.). Thus, the present methods may produce a compressed machine-learned model which is suitable for implementation on a specific data processing system (e.g. a mobile computing device or wearable device), starting from a machine-learned model which is not suitable for implementation on such a device. Here suitability is measured according to a suitability criterion, e.g. such as that the memory requirements to implement the compressed machine-learning model are below a threshold defined based on the specific data processing system, e.g. a certain proportion of the memory capacity of the specific data processing system, or that the number of computing operations required per second to implement the compressed machine-learning model (e.g. so as to complete a computing task within a specific time) is below a threshold. In another example, the compressed machine-learned model may be suitable for implementation in one processor (core) of multi-processor system in which the multiple processors operate in parallel, even though the (uncompressed) machine-learning model is not suitable for implementation in a single processor of the multi-processor system. The specific computer system typically has lower computing capacity (e.g. data storage capacity and/or computational operations per second) than the computer system which performs the present methods to produce the compressed machine-learned model. The compression is such as to ensure that the compressed machine learned model meets a suitability criterion for implementation using the specific data processing system.

As another example technical effect and benefit, large machine-learned models require a substantial quantity of computing resources to store and utilize. As such, by providing the capability to substantially compress large machine-learned models while retaining accuracy implementations of the present disclosure can greatly reduce the quantity of computing resources required for utilization of large machine-learned models (e.g., memory, power, compute cycles, storage, etc.).

With reference now to the Figures, example embodiments of the present disclosure will be discussed in further detail.

### Example Devices and Systems

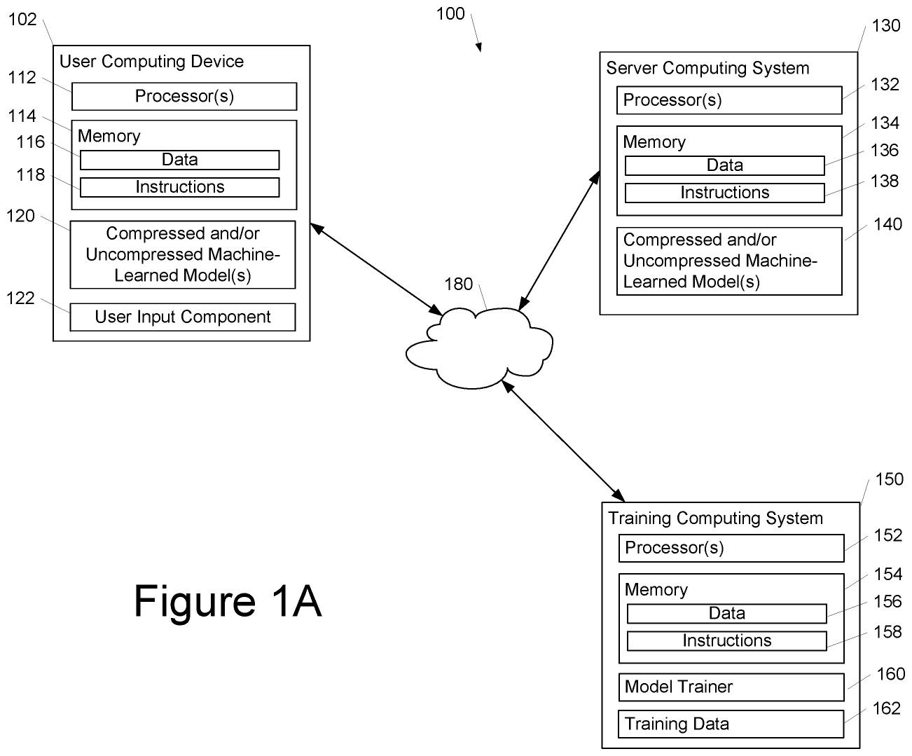

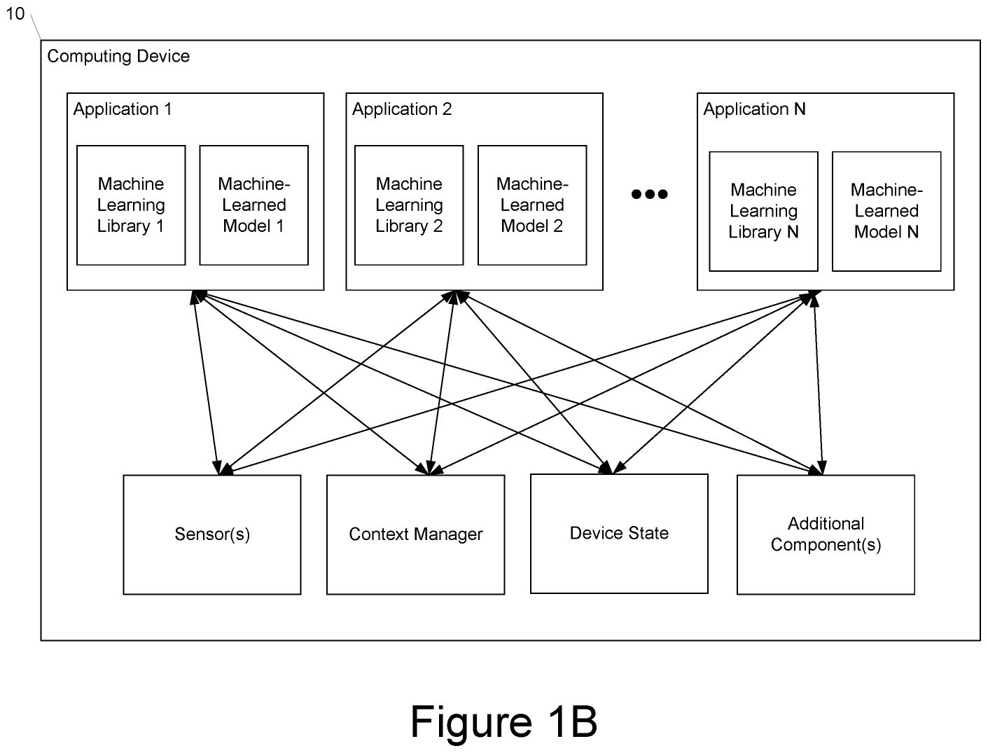

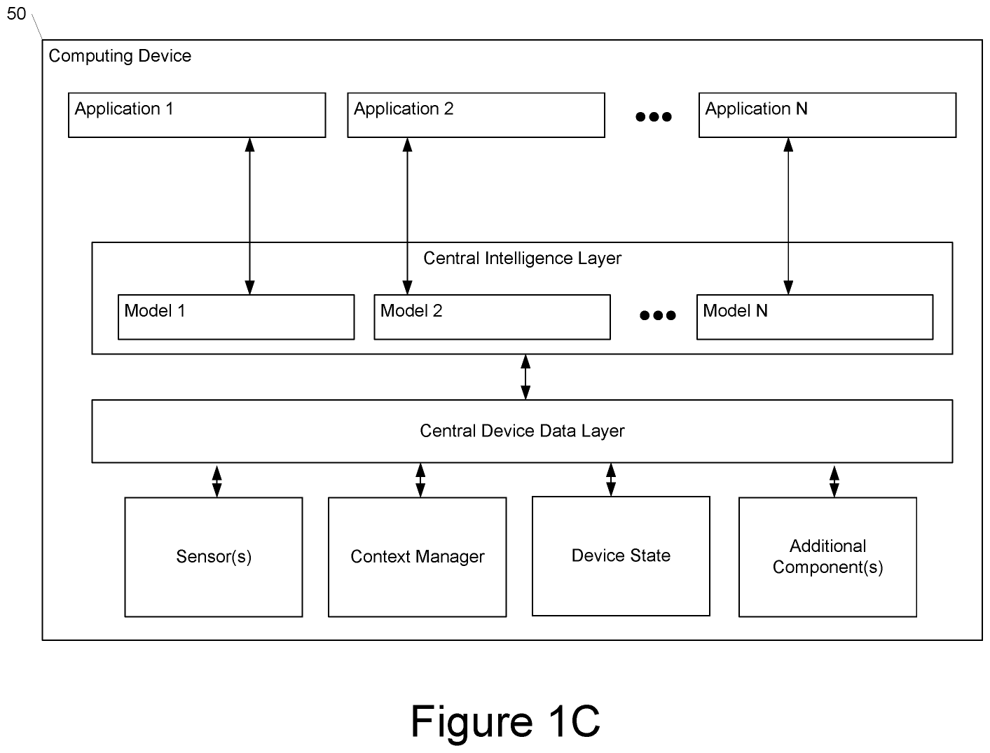

FIG. 1A depicts a block diagram of an example computing system 100 that performs portion-specific compression of machine-learned models according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more models 120. For example, the models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

Specifically, the user computing device 102 can store compressed and/or uncompressed machine-learned models 120. For example, the user computing device 102 can transmit an uncompressed machine-learned model 120 to a computing system of a computing service provider (e.g., the server computing system 130, the training computing system 150, etc.). The computing system can compress the model using techniques discussed herein to obtain a compressed machine-learned model 120. The user computing device can receive the compressed machine-learned model 120 from the computing system (e.g., via the network 180, etc.).

In some implementations, the one or more models 120 can be received from the server computing system 130 over network 180, stored in the user computing device memory 114, and then used or otherwise implemented by the one or more processors 112. For example, the machine-learned model(s) 120 may be trained to perform a variety of task(s) (e.g., task(s) specified by a user, etc.) In some implementations, the user computing device 102 can implement multiple parallel instances of a single model 120 (e.g., to perform parallel user-specified tasks across multiple instances of the machine-learned model(s)).

Additionally, or alternatively, one or more models 140 can be included in or otherwise stored and implemented by the server computing system 130 that communicates with the user computing device 102 according to a client-server relationship. For example, the models 140 can be implemented by the server computing system 130 as a portion of a web service (e.g., a machine-learned task service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. Specifically, in some implementations, the training computing system 150 may train the models 120 and/or 140 and provide the trained models to the user computing device and/or the server computing system 130 for inference. The training computing system 150 can be separate from the server computing system 130 or can be a portion of the server computing system 130. Specifically, as mentioned the server computing system may receive uncompressed machine-learned models (e.g., uncompressed machine-learned models 120) and compress the uncompressed machine-learned models 120 using techniques described herein to obtain compressed machine-learned models 140.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the models 120 and/or 140 based on a set of training data 162. Specifically, in some implementations, the model trainer 160 can train the machine-learned model(s) 120/140 via distillation. For example, the machine-learned models 140 may include an uncompressed machine-learned model and a corresponding machine-learned model. The training computing system 150 can train compressed model portion(s) of the compressed machine-learned model via distillation of the corresponding model portion(s) of the uncompressed machine-learned model.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data (e.g. image data captured by a camera arranged to image a portion of the real-world). The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output, i.e. output data indicating one of a plurality of predefined categories, so that the output data indicates that the content of the image (i.e. a subject depicted in the image) is in one of those categories, i.e. “matches” that category. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output, i.e. output data indicating one of a plurality of predefined categories, so that the output data indicates that the content of the text or natural language data is in one of those categories, i.e. “matches” that category. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be sound data, such as speech data. For example, the sound data may be captured by a microphone, and may record a speaker speaking. The machine-learned model(s) can process the speech data to generate an output. As an example, the machine-learned model(s) can process the speech data to generate a speech recognition output. For example, the machine-learned model(s) can process the speech data to generate a classification output. i.e. output data indicating one of a plurality of predefined categories, so that the output data indicates that the content of a portion of the speech data (i.e. the semantic meaning of that portion of the speech data) is in one of those categories. i.e. “matches” that category. For example, each of the categories may correspond to one of a vocabulary of words, such that the output result indicates which word of the vocabulary is encoded by respective sections of the speech data. As another example, the machine-learned model(s) can process the speech data to generate a speech translation output (e.g. data encoding sound data recording speech data with semantic content equal to that of the speech data, but in a natural language different from the natural language of the speech data). As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output. In another example, the machine-learned model(s) may be configured to use the sensor data to generate control data, to control a real-world electromechanical system (e.g. a robot) in a real-world environment, e.g. to as to perform a task. For example, the electromechanical system may be configured to move (by reconfiguration and/or translation) in a real-world environment, e.g. to perform an object manipulation task or a navigation task.

In some cases, the machine-learned model(s) can be configured to perform a task that includes encoding input data (e.g. image data and/or sound data) for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data).

In some cases, the input includes visual data (e.g. image data as described above) and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement portion-specific compression and optimization of machine-learned models the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs portion-specific compression and optimization of machine-learned models according to example implementations of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs distillation training for portion-specific optimization of machine-learned models according to example implementations of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

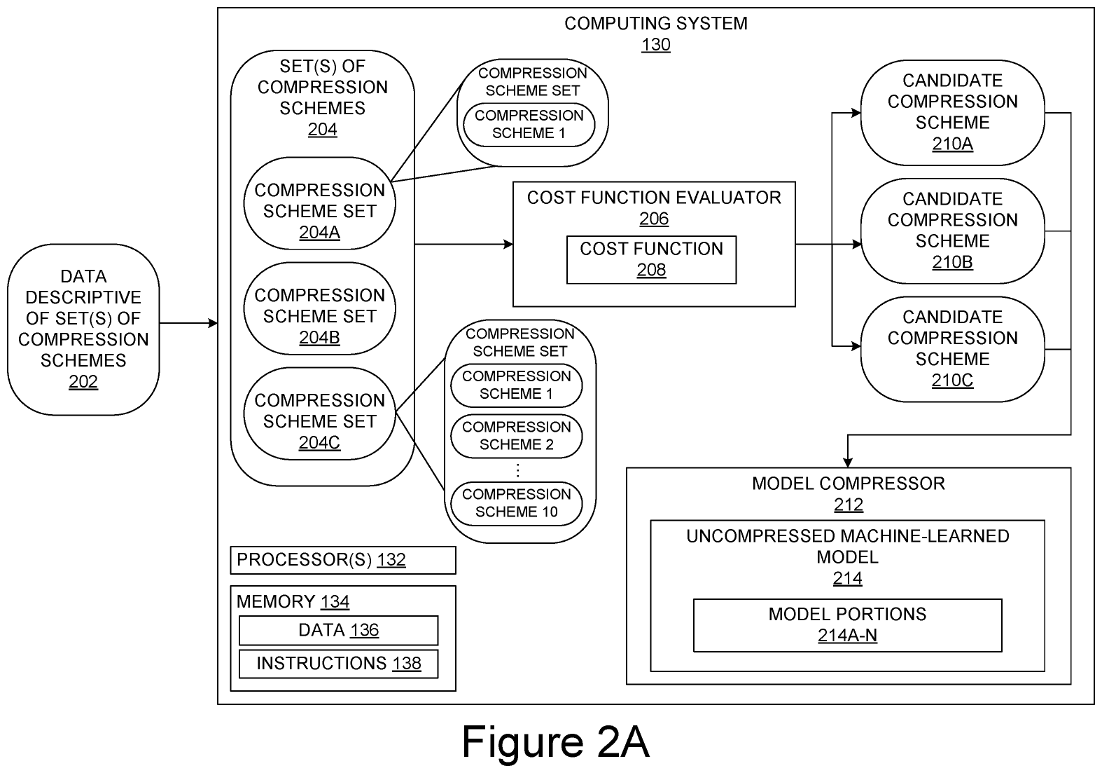

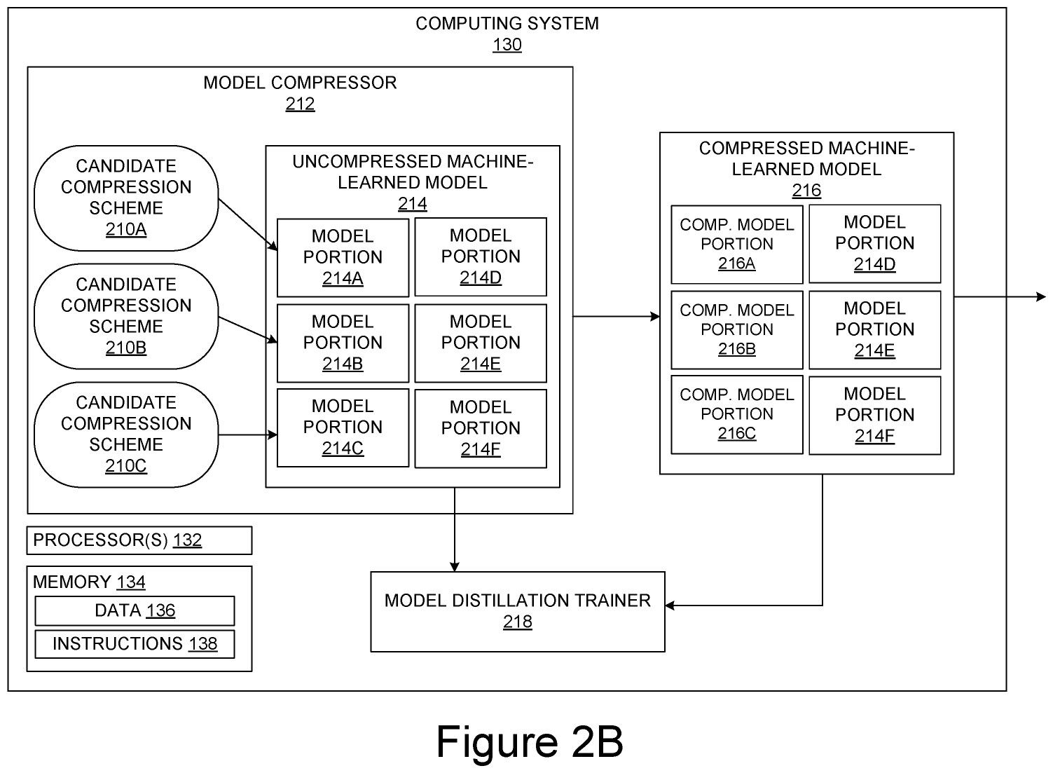

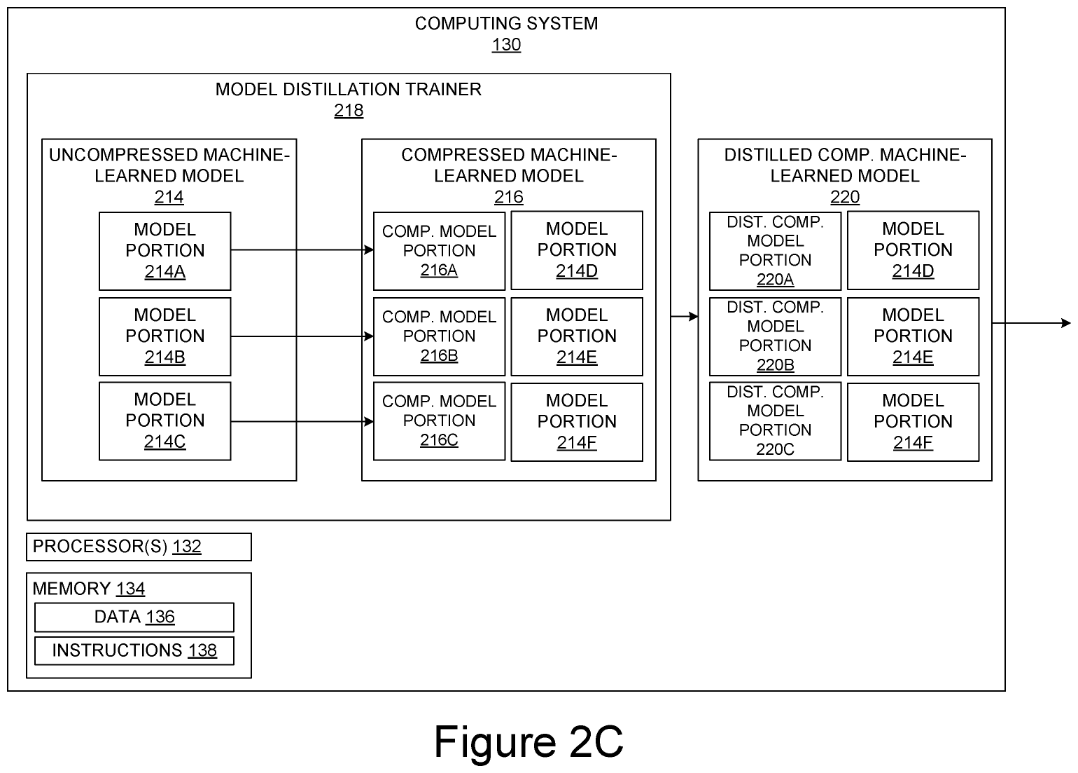

FIG. 2A depicts a block diagram of an example computing system 130 that evaluates a cost function to determine candidate compression scheme(s) according to some embodiments of the present disclosure. Specifically, the computing system 130 (e.g., server computing system 130 of FIG. 1A, etc.) can include processor(s) 132 and memory 134, which includes data 136 and instructions 138, as described previously with regards to FIG. 1A. The computing system 130 can receive data descriptive of set(s) of compression scheme(s) 202. In some implementations, the computing system 130 may receive the data 202 from a computing device of a user of a cloud computing service. For example, the data 202 may be or otherwise indicate a selection by a user of sets of compression scheme(s) for utilization in a cloud-based machine-learned model compression service.

In some implementations, the computing system 130 can include set(s) of compression schemes 204. The set(s) of compression schemes 204 can include compression scheme set 204A, compression scheme set 204B, and compression scheme set 204C. It should be noted that, although the set(s) of compression schemes 204 is illustrated with three sets of compression schemes, embodiments of the present disclosure are not limited to three sets of compression schemes. Rather, the set(s) of compression schemes 204 can include any number of compression scheme(s) (e.g., one set, ten sets, etc.). For example, the computing system 130 may include a large variety of compression schemes that can be utilized to compress machine-learned models. The set(s) of compression schemes 204 can be selected from the variety of compression schemes included in the computing system 130 (e.g., based on the data 202, etc.). Additionally, or alternatively, in some implementations, the data 202 may include the set(s) of compression schemes 204.

The set of compression schemes 204 can include one or more compression schemes that can be utilized for compression of machine-learned models. For example, as illustrated, compressions scheme set 204A can include one compression scheme and compression scheme set 204C can include 10 compression schemes. Each of the compression scheme(s) included in the set of compression scheme(s) 204 can be any type of compression scheme sufficient to compress or otherwise encode a model portion of a machine-learned model.

Each of the sets of compression schemes 204 can be selected for compression of a corresponding model portion of an uncompressed machine-learned model 214. A model portion of a machine-learned model can refer to any component, element, segment of data, feature, grouping of feature(s), etc. of a machine-learned model (e.g., layer(s), tensor(s), a grouping of layer(s) and tensor(s), etc.). For example, compression scheme set 204A may include one compression scheme for compression of a model portion 214A of the machine-learned model 214 that is or otherwise includes a convolutional layer. For another example, the compression scheme set 204B may include a number of compression schemes for compression of a model portion 214B that is or otherwise includes a tensor. For yet another example, the compression scheme set 204C may include a number of compression schemes for compression of a model portion 214C that includes a recurrent layer and one or more associated tensors.

The computing system 130 can include a cost function evaluator 206. The cost function evaluator 206 can evaluate a cost function 208 to determine candidate compression scheme(s) 210 from the set(s) of compression schemes 204. For example, the cost function evaluator 206 can evaluate the cost function 208 to select candidate compression scheme 210A from compression scheme set 204A, candidate compression scheme 210B from compression scheme set 204B, and candidate compression scheme 210C from compression scheme set 204C.

In some implementations, the cost function 208, when evaluated by the cost function evaluator 206, can evaluate changes in an accuracy metric and a performance metric (e.g., as measured in floating-point operations per second (FLOPS)) associated with compression of a model portion 214A-N. For example, the cost function evaluator 206 can evaluate the cost function 208 to determine changes in the accuracy metric and the performance metric associated with compression of a model portion 214C of the uncompressed machine-learned model 214 with each compression scheme in the compression scheme set 204C. Based on the changes in the accuracy and performance metric, the cost function evaluator 206 can select the candidate compression scheme 210C from the compression scheme set 204C. The performance metric may be selected to provide a constraint to ensure that the compressed machine-learned model meets a suitability criterion with respect to a specific data processing system. For example, it may provide a high contribution to the cost function if the suitability criterion is not met.

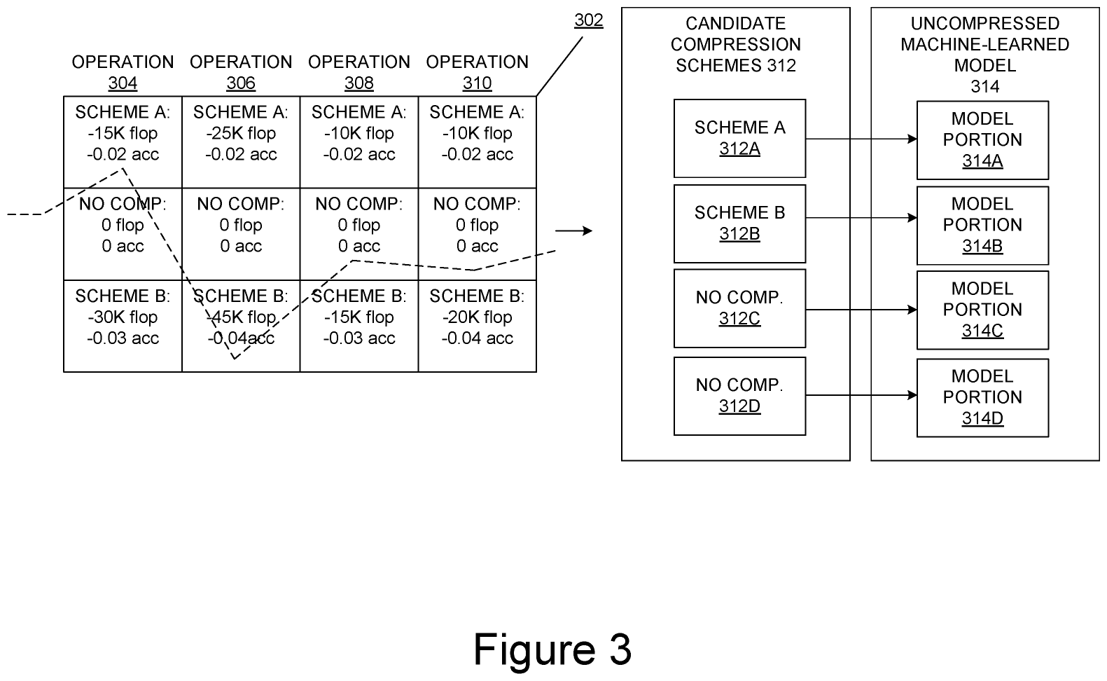

In some implementations, the cost function can evaluate the changes in the accuracy metric and the performance metric using a combinatorial search space. Turning to FIG. 3, FIG. 3 is a data flow diagram that illustrates selection of compression schemes using a combinatorial search space 302 according to some implementations of the present disclosure. As illustrated, the search space 302 can be evaluated (e.g., by the cost function evaluator 206 of FIG. 2A, etc.) to determine candidate compression schemes 312 (e.g., candidate compression schemes 210 of FIG. 2A, etc.) for compression of a machine-learned model 314 (e.g., machine-learned model 214 of FIG. 2A, etc.).

For example, at operation 304, the search space 302 can be evaluated to determine whether to select compression scheme A, compression scheme B, or no compression scheme for a corresponding model portion (e.g., a model portion of the model 214 of FIG. 2A, etc.). Based on the changes in the accuracy metric (e.g., −0.02 acc) and the performance metric (e.g., −15 k flop), compression scheme A can be selected as a candidate compression scheme 312A for compression of model portion 314A of the uncompressed machine-learned model 314. At operation 306, the search space 302 can be evaluated to select compression scheme B as candidate compression scheme 312B for compression of model portion 314B. At operation 308, the search space 302 can be evaluated to select no compression scheme as a candidate compression scheme 312C for compression of model portion 314C. In other words, the search space 302 can be evaluated to determine not to compress model portion 314C. Similarly, at operation 310, the search space 302 can be evaluated to select no compression scheme as a candidate compression scheme 312D for compression of model portion 314D.

In such fashion, the search space 302 can be evaluated iteratively to select a set of candidate compression schemes 312 that collectively optimize the search space, or the cost function that evaluates the search space (e.g., cost function 208 of FIG. 2A). As such, it should be noted that the search space 302, and the cost function, do not necessarily select (or determine not to select) a compression scheme for a model portion without accounting for the effect of the selection on selection of compression schemes for other model portions. Rather, when evaluated, the search space 302 and the cost function can select a set of candidate compression schemes 312 that collectively optimize the accuracy metric and the performance metric. For example, the cost function may evaluate the search space 302 with the following parameters:

$$Objective : Max ( Δ accuracy )$$

$$Constraint : Δ FLOP < ( target\_flop - current\_flop ) ;$$

$$Attributes :$$

$$\begin{matrix}Δ FLOP = \sum Δ FLOP ( i ) \\ Δ Acc != \sum Δ {Acc ( i )}^{′}\end{matrix}$$

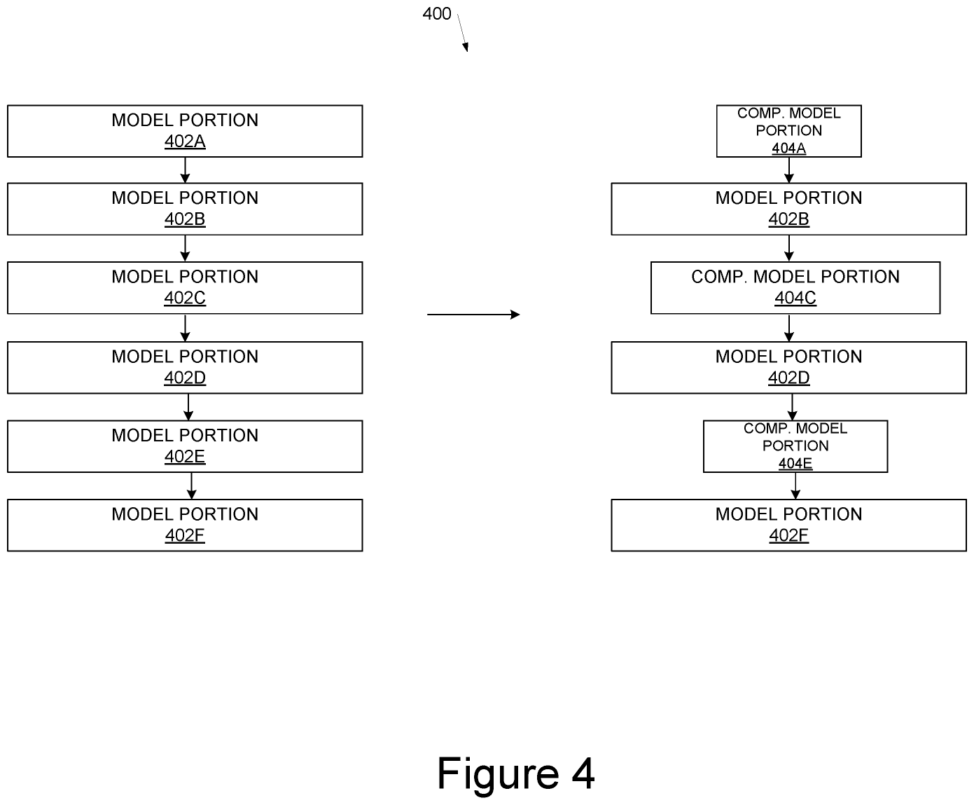

It should be noted that, in some implementations, other forms of search spaces may be utilized to evaluate changes in the accuracy metric and the performance metric. Turning to FIG. 4, FIG. 4 is a block diagram that illustrates an example layer-wise search space that can be utilized by a cost function according to some implementations of the present disclosure. Specifically, in some implementations, the search space may be a portion-wise or layer-wise search space/size search space 400. As illustrated, the search space 400 can be evaluated to determine, for each layer 402 of a machine-learned model, whether the layer of the model should be compressed to obtain a corresponding compressed layer 404, and if so, to what degree the layer should be compressed. For example, as depicted, the layer-wise search space 400 may be evaluated to select a set of candidate compression schemes that maximize an accuracy of the compressed model while minimizing a cost (e.g., a performance cost). The set of candidate compression schemes can include schemes for compressing model portions 402A, 402C, and 404E. The compression schemes can be applied to obtain compressed model portions 402A, 404C, and 404E. As depicted, each of the compressed model portions 402A, 404C, and 404E can be a different size due to the different compression schemes utilized to generate them.

Returning to FIG. 2A, as described previously, the candidate compression schemes 210 can be selected with the cost function evaluator 206. The candidate compression schemes 210 can be provided to the model compressor 212 for compression of the model portions 214A-N of the uncompressed machine-learned model 214.

It should be noted that, in some implementations, the cost function 208 may not be evaluated to select the candidate compression schemes 210. Specifically, in some implementations, the compression scheme sets 204A-204C may each include one compression scheme. As each of the sets of the compression schemes 204 would only include a single compression scheme, it would not be necessary to evaluate a cost function to select candidate compression schemes. Rather, the sets of compression scheme(s) 204 would include the candidate compression schemes 210A-210C, and could be provided directly to the model compressor 212.

FIG. 2B depicts a block diagram of an example computing system 130 that compresses portions of an uncompressed machine-learned model to obtain a compressed machine-learned model according to some implementations of the present disclosure. The model compressor 212 can apply the candidate compression schemes 210 to model portions 214A-N of the uncompressed machine-learned model 214 to obtain a compressed machine-learned model 216. Specifically, the model compressor can respectively apply candidate compression schemes 210A, 210B, and 210C to the model portions 214A, 214B, and 214C to obtain compressed model portions 216A, 216B, and 216C. The compressed model portions 216A-216C can be included in the compressed machine-learned model 216 alongside the model portions 214D, 214E, and 214F of the uncompressed machine-learned model 214.

In such fashion, a subset of model portions 214A-214F of the uncompressed machine-learned model 214 can be compressed to obtain the compressed machine-learned model 216. It should be noted that, although the compressed machine-learned model 216 is only partially compressed (i.e., model portions 214D-214F remain uncompressed), implementations of the present disclosure are not limited to partial compression of machine-learned models. Rather, the sets of compression schemes 204 of FIG. 2A may instead include compression scheme sets 204A-204F, which can provide candidate compression schemes 210A-210F for compression of model portions 214A-214F, therefore fully compressing the uncompressed machine-learned model 214.

In some implementations, the compressed machine-learned model 216 can be provided to a second computing device. For example, the computing system 130 may be a cloud computing system that provides model compression services for users. The uncompressed machine-learned model 214 may be a model provided alongside the data descriptive of set(s) of compression scheme(s) 202 of FIG. 2A for compression services. The computing system 130 can provide the compressed machine-learned model 216 to a computing device associated with the user. Alternatively, in some implementations, the compressed machine-learned model 216 can be provided to the model distillation trainer 218 for distillation training of the compressed machine-learned model 216.

FIG. 2C depicts a block diagram of an example computing system 130 that trains compressed portions of a compressed machine-learned model via distillation training from corresponding uncompressed portions of a corresponding uncompressed model according to some implementations of the present disclosure. Specifically, the model distillation trainer can perform portion-wise distillation from the uncompressed machine-learned model 214 to the compressed machine-learned model 216. For example, the model distillation trainer 218 can train the compressed model portion 216A via distillation of the model portion 214A, the compressed model portion 216B via distillation of the model portion 214B, and the compressed model portion 216C via distillation of the model portion 214C.

For a specific example, to train the compressed model portion 216A via distillation, the model distillation trainer 218 may load weights of parameters from the model portion 214A to the compressed model portion 216A. The model distillation trainer 218 can only train the compressed model portion 216A for a series of training iterations (e.g., 10,000 iterations, etc.) by evaluating a loss function that evaluates a difference between an intermediate output of the model portion 214A and an intermediate output of the compressed model portion 216A. The model distillation trainer 218 may then concurrently train the first and second compressed model portions 216A/216B for a number of iterations in the same manner as previously described.

In some implementations, to train compressed model portions 216A-216C via distillation, the model distillation trainer 218 can map values of parameters from portions of the uncompressed machine-learned model 214 to the portions of the compressed machine-learned model 216. For example, to train uncompressed model portion 216A via distillation, the model distillation trainer 218 can map values from a set of parameters of the model portion 214A to a corresponding set of parameters of the compressed model portion 216A. The compressed model portion 216A can be trained via distillation of the model portion 214A. In some implementations, the compressed model portion 216A can be trained concurrently with all other portions of the model 216 as the model is trained end-to-end. Alternatively, in some implementations, the parameters of the other portions may be frozen while distillation training is initially performed on the compressed model portion 216A alone.

### Example Methods

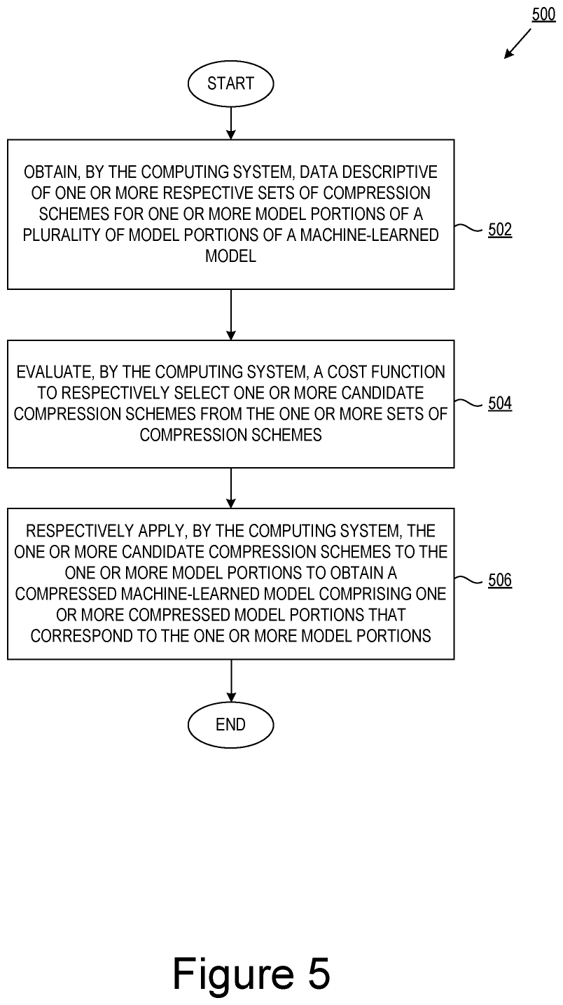

FIG. 5 depicts a flow chart diagram of an example method 500 to perform portion-specific compression of machine-learned models according to example implementations of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, a computing system obtains data descriptive of one or more respective sets of compression schemes for one or more model portions of a plurality of model portions of a machine-learned model.

At 504, the computing system evaluates a cost function to respectively select one or more candidate compression schemes from the one or more sets of compression schemes. Specifically, to evaluate the cost function, the computing system can perform a search within a search space to evaluate model quality and cost after application of candidate compression schemes to respectively select the candidate compression scheme(s)

At 506, the computing system respectively applies the one or more candidate compression schemes to the one or more model portions to obtain a compressed machine-learned model comprising one or more compressed model portions that correspond to the one or more model portions.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for portion-specific compression and optimization of machine-learned models, comprising:
obtaining, by a computing system comprising one or more computing devices, data descriptive of one or more respective sets of compression schemes for one or more model portions of a plurality of model portions of a machine-learned model;
evaluating, by the computing system, a cost function to respectively select one or more candidate compression schemes from the one or more sets of compression schemes; and
respectively applying, by the computing system, the one or more candidate compression schemes to the one or more model portions to obtain a compressed machine-learned model comprising one or more compressed model portions that correspond to the one or more model portions.

2. The computer-implemented method of claim 1, wherein the method further comprises:
training, by the computing system, the compressed machine-learned model via distillation of the machine-learned model.

3. The computer-implemented method of claim 2, wherein training the compressed machine-learned model via distillation of the machine-learned model comprises training, by the computing system, the one or more compressed model portions via distillation of the one or more corresponding portions of the machine-learned model.

4. The computer-implemented method of claim 2, wherein training the one or more compressed model portions via distillation of the one or more corresponding portions of the machine-learned model comprises:
for each compressed model portion of the one or more compressed model portions, mapping, by the computing system, values from a set of parameters of a corresponding model portion of the machine-learned model to a corresponding set of parameters of the compressed model portion; and
training, by the computing system, the one or more compressed model portions via distillation of the one or more corresponding portions of the machine-learned model.

5. The computer-implemented method of claim 4, wherein training the one or more compressed model portions via distillation comprises, for each of the one or more compressed model portions:
processing, by the computing system, an input with a compressed model portion to obtain a first output;
processing, by the computing system, the input with the corresponding model portion to obtain a second output; and
training, by the computing system, the compressed model portion based on a loss function that evaluates a difference between the second output and the first output.

6. The computer-implemented method of claim 1, wherein evaluating the cost function to respectively select the one or more candidate compression schemes comprises evaluating, by the computing system, a cost function that evaluates changes in an accuracy metric and a performance metric associated with compression of a model portion using a candidate compression scheme to respectively select the one or more candidate compression schemes from the one or more sets of compression schemes.

7. The computer-implemented method of claim 6, wherein the cost function evaluates changes in the accuracy metric and the performance metric using a combinatorial search space.

8. The computer-implemented method of claim 7, wherein the performance metric is indicative of whether, following the compression of the model portion, the compressed machine learned model meets a suitability criterion for implementation using a specific data processing system having lesser computational capacity than the computing system.

9. The computer-implemented method of claim 8, wherein the specific data processing system is a mobile or wearable computing device.

10. The computer-implemented method of claim 1, wherein the machine learned model is adapted to perform a computational task based on input data which is selected from image data, speech data or sensor data.

11. The computer-implemented method of claim 10, wherein the computational task is to generate classification data indicative of which one of a predetermined plurality of categories matches content of the input data.

12. The computer-implemented method of claim 1, wherein obtaining the data descriptive of the one or more respective sets of compression schemes comprises:
obtaining, by the computing system from a user device, data descriptive of selection of the one or more respective sets of compression schemes for the one or more model portions of a plurality of model portions of a machine-learned model.

13. The computer-implemented method of claim 1, wherein a portion of a machine-learned model comprises one or more tensors and/or one or more layers of the machine-learned model.

14. A computer-implemented method of employing a compressed machine-learned model obtained by a method according to claim 1 to perform a computational task of processing input data to form output data, wherein the input data is selected from image data, speech data or sensor data.

15. The computer-implemented method of claim 14, in which the computation task is to generate classification data indicative of which one of a predetermined plurality of categories matches content of the input data.

16. A computing system for portion-specific compression and optimization of machine-learned models, comprising:
one or more processors; and
one or more non-transitory computer-readable media that store instructions that, when executed by the one or more processors, cause the computing system to perform operations, the operations comprising:
obtaining data descriptive of one or more respective sets of compression schemes for one or more model portions of a plurality of model portions of a machine-learned model;
evaluating a cost function to respectively select one or more candidate compression schemes from the one or more sets of compression schemes; and
respectively applying the one or more candidate compression schemes to the one or more model portions to obtain a compressed machine-learned model comprising one or more compressed model portions that correspond to the one or more model portions.

17. The computing system of claim 16, wherein the operations further comprise:
training the compressed machine-learned model via distillation of the machine-learned model.

18. The computing system of claim 17, wherein training the compressed machine-learned model via distillation of the machine-learned model comprises training the one or more compressed model portions via distillation of the one or more corresponding portions of the machine-learned model.

19. The computing system of claim 17, wherein training the one or more compressed model portions via distillation of the one or more corresponding portions of the machine-learned model comprises:
for each compressed model portion of the one or more compressed model portions, mapping values from a set of parameters of a corresponding model portion of the machine-learned model to a corresponding set of parameters of the compressed model portion; and
training the one or more compressed model portions via distillation of the one or more corresponding portions of the machine-learned model.

20. The computing system of claim 19, wherein training the one or more compressed model portions via distillation comprises, for each of the one or more compressed model portions:
processing an input with a compressed model portion to obtain a first output;
processing the input with the corresponding model portion to obtain a second output; and
training the compressed model portion based on a loss function that evaluates a difference between the second output and the first output.

21. The computing system of claim 16, wherein evaluating the cost function to respectively select the one or more candidate compression schemes comprises evaluating a cost function that evaluates a difference between an accuracy metric and a performance metric associated with compression of a model portion using a candidate compression scheme to respectively select the one or more candidate compression schemes from the one or more sets of compression schemes.

22. The computing system of claim 21, wherein the cost function evaluates changes in the accuracy metric and the performance metric using a topology search space or a portion-wise search space.

23. The computing system of claim 16, wherein obtaining the data descriptive of the one or more respective sets of compression schemes comprises:
obtaining, from a user device, data descriptive of selection of the one or more respective sets of compression schemes for the one or more model portions of a plurality of model portions of a machine-learned model.

24. The computing system of claim 16, wherein a portion of a machine-learned model comprises one or more tensors and/or one or more layers of the machine-learned model.

25. One or more non-transitory computer-readable media that store instructions that, when executed by one or more processors, cause the one or more processors to perform operations, the operations comprising:
obtaining data descriptive of a user selection of one or more candidate compression schemes from one or more respective sets of compression schemes for compression of one or more respective model portions of a plurality of model portions of an uncompressed machine-learned model; and
applying the one or more compression schemes to one or more respective model portions of the plurality of model portions of the uncompressed machine-learned model to obtain a compressed machine-learned model.

26. The one or more non-transitory computer-readable media of claim 25, wherein the compressed machine-learned model comprises one or more uncompressed model portions of the uncompressed machine-learned model.
